(19) United States
(12) Patent Application Publication
(10) Pub. No.: US 2025/0012592 A1
(43) Pub. Date: Jan. 9, 2025

(54) NAVIGATION DEVICE AND STORAGE MEDIUM

(71) Applicant: TOYOTA JIDOSHA KABUSHIKI KAISHA, Aichi-ken (JP)

(72) Inventor: Yuto KAIDA, Nagoya-shi (JP)

(21) Appl. No.: 18/764,082

(22) Filed: Jul. 3, 2024

(30) Foreign Application Priority Data
Jul. 7, 2023 (JP) 2023-112117

(51) Int. Cl. G01C 21/36

(52) U.S. Cl. CPC G01C 21/3667; G01C 21/3632

(57) ABSTRACT

A navigation device includes an information processor, a display, and an input device. The information processor is configured to obtain information on present positions of vehicles. The vehicles include a subject vehicle. The information processor is configured to show on the display a navigation image in which an icon indicating the present position of a corresponding vehicle is superimposed on a map image of a subject range; generate, as the navigation image, a normal image in which the subject range includes the present position of the subject vehicle, an overall image in which the subject range includes the present positions of all the vehicles, and a confirmation image in which the subject range includes the present position of a specified vehicle, which is designated, and switch a manner in which three types of the navigation images are displayed in accordance with an input from the input device.

### CROSS-REFERENCE TO RELATED APPLICATIONS

This application is based upon and claims the benefit of priority from prior Japanese Patent Application No. 2023-112117, filed on Jul. 7, 2023, the entire contents of which are incorporated herein by reference.

### BACKGROUND

### 1. Field

The following description relates to a navigation device and a storage medium.

### 2. Description of Related Art

Japanese Laid-Open Patent Publication No. 2009-030993 discloses a vehicle including a navigation device. The navigation device includes a control unit and a display device. The control unit stores map data. The control unit obtains information on the present position of the vehicle on which the control unit is mounted. The control unit shows a map image of an area around the present position of the vehicle on the display device. Further, the control unit shows an icon indicating the present position of the vehicle on the map image.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A first aspect of the present disclosure provides a navigation device. The navigation device is mounted on a vehicle. The navigation device includes an information processor, a display, and an input device. The information processor stores map data in advance. The display is configured to show an image that corresponds to information output by the information processor. The input device is configured to input information to the information processor from outside the information processor. The information processor is configured to obtain information on present positions of vehicles registered in advance. The vehicles include a subject vehicle on which the navigation device is mounted. The information processor is configured to show on the display a navigation image in which an icon indicating the present position of a corresponding one of the vehicles is superimposed on a map image of a subject range. The information processor is configured to generate, as the navigation image, a normal image in which the subject range is set to a range including the present position of the subject vehicle, an overall image in which the subject range is set to a range including the present positions of all of the vehicles, and a confirmation image in which the subject range is set to a range including the present position of a specified vehicle designated by an input from the input device. The specified vehicle is one of the vehicles. The information processor is configured to switch a manner in which three types of the navigation images are displayed in accordance with an input from the input device.

A second aspect of the present disclosure provides a non-transitory computer readable storage medium storing a navigation program that includes instructions executed by a computer. The instructions of the navigation program cause the computer to obtain information on present positions of vehicles registered in advance, the vehicles including a subject vehicle on which the navigation device is mounted; output, to outside the storage medium, a navigation image in which an icon indicating the present position of a corresponding one of the vehicles is superimposed on a map image of a subject range; generate, as the navigation image, a normal image in which the subject range is set to a range including the present position of the subject vehicle, an overall image in which the subject range is set to a range including the present positions of all of the vehicles, and a confirmation image in which the subject range is set to a range including the present position of a specified vehicle designated by an input from outside the storage medium, the specified vehicle being one of the vehicles; and switch a manner in which three types of the navigation images are displayed in accordance with an input from outside the storage medium.

The first and second aspects of the present disclosure improve convenience for a user when the user makes a driving plan taking into consideration the movement of the other vehicles.

Other features and aspects will be apparent from the following detailed description, the drawings, and the claims.

### BRIEF DESCRIPTION OF THE DRAWINGS

FIG. 1 is a diagram showing a schematic configuration of a navigation device.

FIG. 2 is a flowchart illustrating the procedure of a processing routine.

FIG. 3 is a diagram showing an example of a normal image.

FIG. 4 is a diagram showing an example of an overall image.

FIG. 5 is a diagram showing an example of a confirmation image.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Overall Configuration

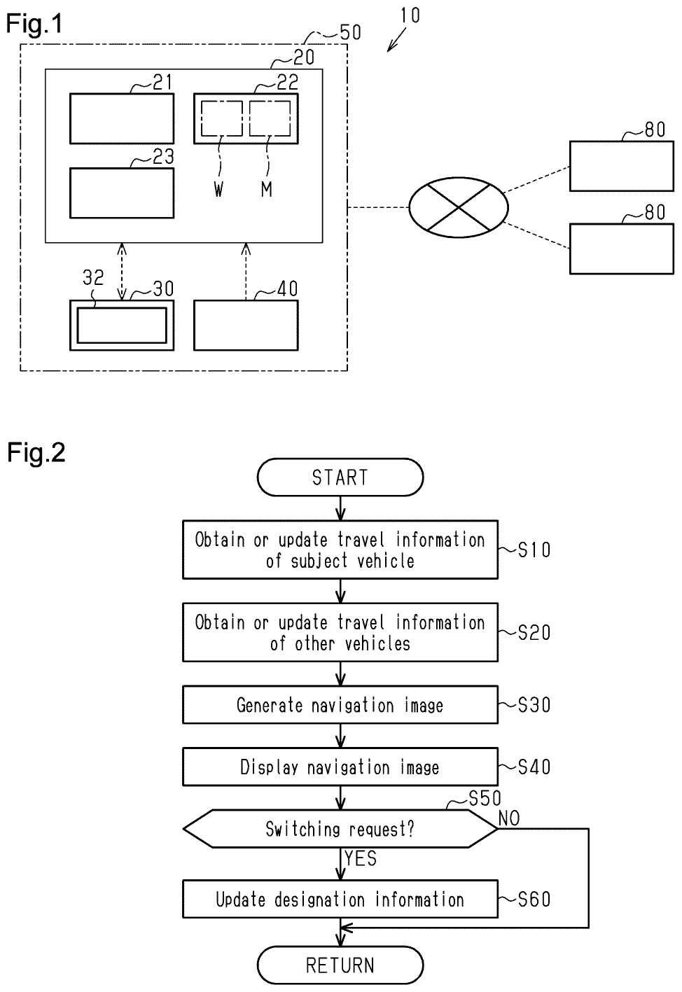

An embodiment of a navigation device and a storage medium will now be described with reference to the drawings. As shown in FIG. 1, a navigation device 50 is mounted on a vehicle 10. Hereinafter, the vehicle 10 on which the navigation device 50 is mounted will be referred to as the subject vehicle 10. The navigation device 50 includes an information processor 20, a display 30, and a position receiver 40. The information processor 20 is a computer arranged in the subject vehicle 10. The information processor 20 may be a portable terminal carried by the driver. The information processor 20 includes a central processing unit (CPU) 21, a memory 22, and a communication circuit 23. The memory 22 stores in advance a navigation program W in which processing to be executed by the CPU 21 is described. That is, the memory 22 stores, as a non-transitory computer-readable storage medium, the navigation program W including instructions executed by a computer. The communication circuit 23 is a circuit for performing wireless communication with an external device outside of the subject vehicle 10 via an external communication network. Hereinafter, a general vehicle that is not limited to the subject vehicle 10 will be referred to as “vehicle” without reference numerals.

The display 30 is arranged inside the passenger compartment of the subject vehicle 10. The display 30 includes a drive circuit (not shown) and a display screen 32. The display 30 is configured to establish communication with the information processor 20. The display 30 shows on the display screen 32 an image that corresponds to information output by the information processor 20. The display 30 is of a touch panel type. When a user performs an input operation on the display screen 32, the display 30 outputs information corresponding to the input operation to the information processor 20. In this manner, the display 30 has both a functionality of a display device and a functionality of an input device for inputting information to the information processor 20 from outside.

The position receiver 40 receives information related to the present position of the subject vehicle 10 from a global positioning satellite. The position receiver 40 outputs the received information to the information processor 20. Specifically, the information related to the present position is position coordinates represented by a latitude and a longitude.

The memory 22 of the information processor 20 stores map data M in advance. The map data M includes information of nodes and links. Each node indicates position coordinates of a specific location on the road. Each link is defined as a line segment connecting adjacent nodes. Therefore, each link indicates a road.

The memory 22 of the information processor 20 stores base information of the subject vehicle 10 and base information of each of other vehicles 80 in advance. These vehicles are registered in advance as vehicles that can share travel information with one another. The base information includes an ID of the vehicle and a registered name of the vehicle. The other vehicles 80 each include the same navigation device as the subject vehicle 10. FIG. 1 shows an example in which there are two other vehicles 80. The number of the other vehicles 80 is not limited to two.

### Travel Route Guidance

The CPU 21 of the information processor 20 executes the navigation program W stored in the memory 22 to perform the procedure of a processing routine described below. The CPU 21 starts the processing routine when the driver inputs a destination through the display 30. When the destination is input, the CPU 21 stores the input destination in the memory 22. The CPU 21 actually stores the position coordinates of the destination in the memory 22. Once the processing routine is started, the CPU 21 repeats the processing routine until an ending condition is satisfied. The ending condition is satisfied when an end button BE arranged on a navigation image, which will be described later, is operated. When the ending condition is satisfied, the CPU 21 ends the processing routine at that point in time. The content of the processing routine will now be described below.

As shown in FIG. 2, when the processing routine is started, the CPU 21 first proceeds to step S10. In step S10, the CPU 21 obtains or updates travel information of the subject vehicle 10. The travel information includes the present position of the vehicle, a destination of the vehicle, a scheduled travel route from the present position to the destination, a required time to the destination, and an estimated arrival time at the destination. In the travel information, the required time and the estimated arrival time are collectively referred to as time-related information. As a specific process of step S10, the CPU 21 obtains the most recent information related to the present position of the subject vehicle 10 from the position receiver 40. Next, the CPU 21 obtains the destination from the memory 22. The CPU 21 then calculates a scheduled travel route from the present position of the subject vehicle 10 to the destination based on the destination and the map data M. Next, the CPU 21 calculates the required time from the present position of the subject vehicle 10 to the destination and the estimated time of arrival at the destination based on the scheduled travel route. The calculation of the scheduled travel route, the required time, and the estimated arrival time by the CPU 21 corresponds to the acquisition of these pieces of information by the CPU 21. When the CPU 21 obtains the present position of the subject vehicle 10, the destination, the scheduled travel route, the required time, and the estimated arrival time, the CPU 21 stores these pieces of information in the memory 22 as a set of travel information. In this case, if there is previously stored travel information, the CPU 21 overwrites the travel information with the new set of travel information. As a result, the CPU 21 updates the travel information. Subsequently, the CPU 21 proceeds to step S20.

In step S20, the CPU 21 obtains or updates travel information of each of the other vehicles 80. As a premise of step S20, each of the other vehicles 80 has repeatedly transmitted the travel information to the subject vehicle 10. In step S20, the CPU 21 obtains the most recent travel information transmitted from each of the other vehicles 80. When a destination is not set in the other vehicles 80, the CPU 21 obtains only the present positions of the other vehicles 80 as the travel information. The CPU 21 stores the obtained travel information of each of the other vehicles 80 in the memory 22 for each of the vehicles. In the same manner as step S10, if there is previously stored travel information of any of the other vehicles 80, the CPU 21 overwrites the travel information with the new set of travel information. As a result, the CPU 21 updates the travel information of each of the other vehicles 80. Then, the CPU 21 proceeds to step S30.

In step S30, the CPU 21 generates a navigation image of a type that is designated by designation information. The navigation image is an image in which an icon indicating the present position of one or more vehicles is superimposed on a map image of a specific subject range. The navigation image includes three types, namely, a normal image G1, an overall image G2, and a confirmation image G3. The details of each type of the navigation image will be described later. The designation information designates the type of the navigation image requested to be shown on the display 30 from the three types. When the CPU 21 executes the processing routine for the first time, the designation information is set to an initial value. The initial value designates the normal image G1. The designation information is stored in the memory 22. When the CPU 21 generates the navigation image, the CPU 21 proceeds to step S40.

In Step S40, the CPU 21 shows the navigation image generated in step S30 on the entire area of the display screen 32 of the display 30. That is, the CPU 21 outputs, to the display 30, the navigation image generated in step S30 and an instruction signal for displaying the navigation image on the entire area of the display screen 32. Then, the CPU 21 proceeds to step S50. When the CPU 21 shows the navigation image on the display screen 32 in step S40, the CPU 21 continues to show the navigation image until the step S40 is executed again.

In step S50, the CPU 21 waits for a set time. The set time is predetermined as a specified time of, for example, one second or shorter. The CPU 21 determines whether switching is requested during the set time. When the driver does not operate the display 30, the CPU 21 determines that switching is not requested (step S50: NO). In this case, the CPU 21 temporarily ends the processing routine. Then, the CPU 21 returns to step S10.

When the driver operates the display 30, the CPU 21 determines that switching is requested in step S50 (step S50: YES). In this case, the CPU 21 proceeds to step S60.

In step S60, the CPU 21 updates the designation information. The CPU 21 may update specified-vehicle information, which will be described later, appended to the designation information in step S60. A process for updating the designated information and the like will be described later. After updating the designation information, the CPU 21 temporarily ends the processing routine. Then, the CPU 21 returns to step S10.

### Normal Image Generation

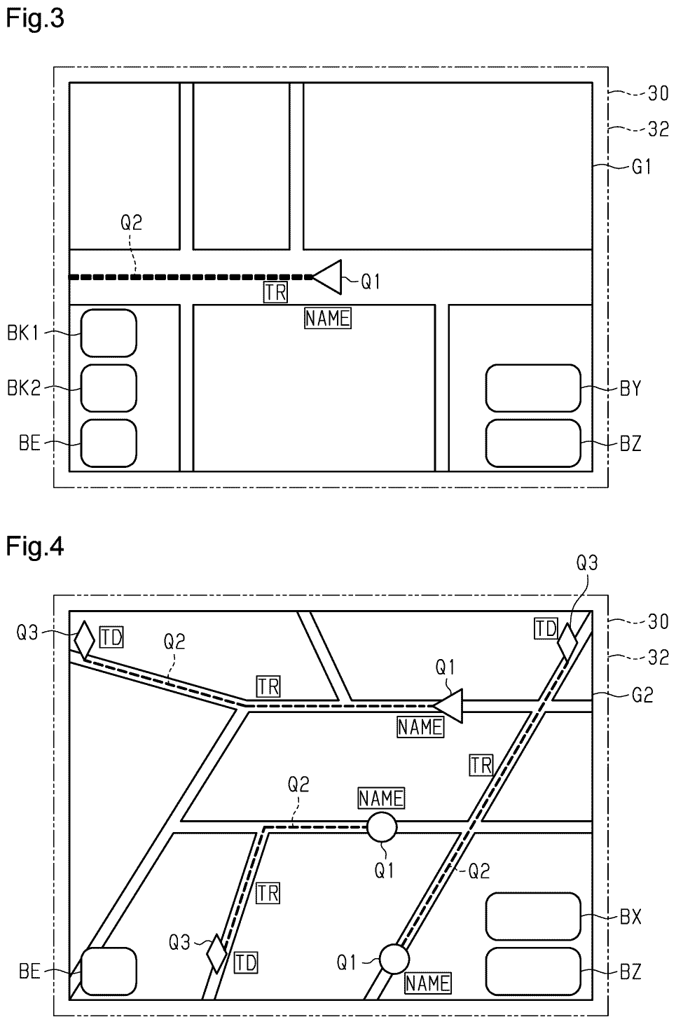

The process of step S30 will now be described in detail. When the normal image G1 is designated by the present designation information in step S30, the CPU 21 generates a normal image G1. As shown in FIG. 3, the normal image G1 is an image in which the subject range of the map image, serving as the base of the normal image G1, is a range including the present position of the subject vehicle 10.

When generating the normal image G1, the CPU 21 first determines the subject range. Specifically, the CPU 21 identifies the present position of the subject vehicle 10 on the map data M based on the travel information of the subject vehicle 10 stored in the memory 22 in step S10. Then, the CPU 21 sets a hypothetical rectangular frame centered on the present position of the vehicle 10 on the map data M on the assumption that the map data M is used at a predetermined scale. The predetermined scale is, for example, a scale set by the driver through the display 30 as described later. When the scale has not been set by the driver, the CPU 21 adopts a base scale as the predetermined scale. The base scale is determined in advance as a scale at which details of the road around the vehicle can be recognized. The base scale is, for example, a scale at which a range of 200 to 400 m around the vehicle is shown on the display 30. The hypothetical rectangular frame is a rectangular frame having a predetermined size. The aspect ratio of the hypothetical rectangular frame is the same as the aspect ratio of the display screen 32 of the display 30. The CPU 21 uses the intersection of two diagonal lines of the hypothetical rectangular frame as the center of the hypothetical rectangular frame. When the hypothetical rectangular frame is set on the map data M, the CPU 21 determines the entire area within the hypothetical rectangular frame as the subject range. When the subject range is determined, the CPU 21 generates a map image of the subject range.

Thereafter, the CPU 21 superimposes display items reflecting the travel information of the subject vehicle 10 on the generated map image. Specifically, the CPU 21 superimposes an icon Q1 indicating the subject vehicle 10 on the present position of the subject vehicle 10 in the generated map image. Further, the CPU 21 superimposes a character string NAME indicating the registered name of the subject vehicle 10 near the icon Q1 of the subject vehicle 10. The CPU 21 also superimposes a line Q2 having the same color as the icon Q1 of the subject vehicle 10 on the scheduled travel route of the subject vehicle 10 in the generated map image. Furthermore, the CPU 21 superimposes a character string TR indicating the required time to the destination near the line Q2 indicating the scheduled travel route. Although not shown in FIG. 1, when the destination of the subject vehicle 10 exists within the range of the generated map image, the CPU 21 superimposes an icon indicating the destination on the map image. At the same time, the CPU 21 superimposes a character string indicating the estimated arrival time around the icon indicating the destination. Although not illustrated in FIG. 1, when the other vehicles 80 are present within the range of the generated map image, the CPU 21 superimposes icons indicating the present positions of the other vehicles 80.

Thereafter, the CPU 21 superimposes various types of operating buttons on the map image. The operating buttons include an ALL button BY, a CONFIRM button BZ, a zoom-in button BK1, a zoom-out button BK2, and an end button BE. The ALL button BY is a button for inputting a first instruction signal to the CPU 21. The first instruction signal is an instruction to switch the navigation image shown on the display 30 to the overall image G2. The ALL button BY corresponds to a first button in the normal image G1. The CONFIRM button BZ is a button for inputting a second instruction signal to the CPU 21. The second instruction signal is an instruction to switch the navigation image shown on the display 30 to the confirmation image G3. The CONFIRM button BZ corresponds to a second button in the normal image G1. For example, the CPU 21 arranges the ALL button BY and the CONFIRM button BZ at the right corner of the map image. The zoom-in button BK1 is a button for inputting an instruction signal for enlarging the navigation image with respect to the present scale to the CPU 21. The zoom-out button BK2 is a button for inputting an instruction signal for reducing the navigation image from the present scale to the CPU 21. The scale set by the zoom-in button BK or the zoom-out button BK2 is the predetermined scale of the map in the normal image G1. The end button BE is a button for inputting an instruction signal for ending the display of the navigation image to the CPU 21. The CPU 21 arranges the zoom-in button BK1, the zoom-out button BK2, and the end button BE, for example, at the left corner of the map image.

### Overall Image Generation

When the overall image G2 is designated by the present designation information in step S30, the CPU 21 generates an overall image G2. As shown in FIG. 4, the overall image G2 is an image in which the subject range of the map image, serving as the base of the overall image G2, is a range including the present positions of all the vehicles. More specifically, the overall image G2 is an image in which the subject range of the map image corresponds to a range including the destinations of all the vehicles in addition to the present positions of all the vehicles. All the vehicles mean the vehicles including the subject vehicle 10 and all of the other vehicles 80.

When generating the overall image G2, the CPU 21 first determines the subject range. The CPU 21 uses the hypothetical rectangular frame described above to determine the subject range. Specifically, the CPU 21 first identifies the present positions of all the vehicles and the destinations of all the vehicles on the map data M based on the travel information of all the vehicles. Then, the CPU 21 sets a hypothetical rectangular frame on the map data M so that the present positions of all the vehicles and the destinations of all the vehicles fall within the hypothetical rectangular frame. The CPU 21 determines the entire region within the hypothetical rectangular frame as the subject range. The subject range of the overall image G2 is a map area as small as possible including the present positions of all the vehicles and the destinations of all the vehicles. After determining the subject range, the CPU 21 generates a map image of the subject range.

Thereafter, the CPU 21 superimposes various types of display items reflecting the travel information of the vehicles on the generated map image. In the same manner as the normal image G1, the display items include an icon Q1 indicating the present position of the vehicles, a character string NAME indicating the registered name of the vehicle, a line Q2 indicating the scheduled travel route of the vehicle, a character string TR indicating the required time to the destination, an icon Q3 indicating the destination, and a character string TD indicating the estimated arrival time at the destination. The date and time when the most recent travel information is transmitted from each vehicle may be added to the display item. The CPU 21 superimposes each display item on the map image for each of the vehicles. The shape of icon Q1 indicating the present position of the subject vehicle 10 is different from the shape of icons Q1 indicating the present positions of the other vehicles 80. The icon Q1 of the subject vehicle 10 is the same as that of the normal image G1. For example, the colors of the icons Q1 of the other vehicles 80 are different for each of the vehicles. This distinguishes the other vehicles 80 from one another. For example, the lines Q2 indicating the scheduled travel routes and the icons Q3 indicating the destinations also have different colors for each of the vehicles.

Thereafter, the CPU 21 superimposes various types of operating buttons on the map image. The operating buttons include a NORMAL button BX, the CONFIRM button BZ, and the end button BE. The NORMAL button BX is a button for inputting a third instruction signal to the CPU 21. The third instruction signal is an instruction to switch the navigation image shown on the display 30 to the normal image G1. The NORMAL button BX corresponds to the first button in the overall image G2. The function of the CONFIRM button BZ is the same as the content described in the normal image G1. The CONFIRM button BZ corresponds to the second button in the overall image G2. The function of the end button BE is the same as the content described in the normal image G1. In the same manner as the normal image G1, the operating buttons are arranged, for example, at the left and right corners of the map image.

### Confirmation Image Generation

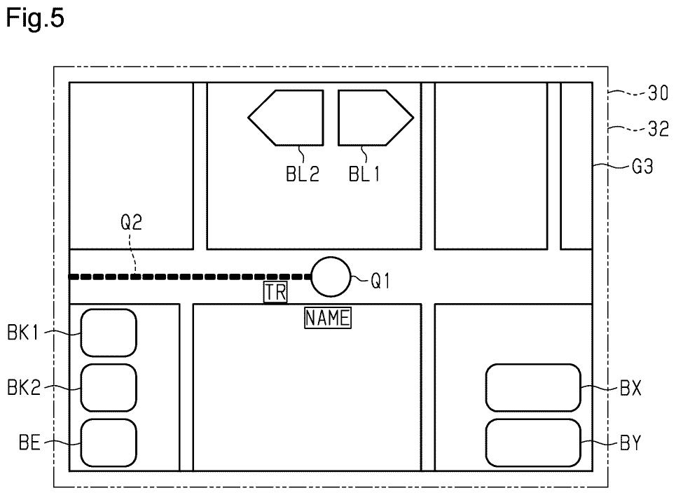

When the confirmation image G3 is designated by the present designation information in step S30, the CPU 21 generates a confirmation image G3. As shown in FIG. 5, the confirmation image G3 is an image in which the subject range of the map image, serving as the base of the confirmation image G3, is a range including the present position of a specified vehicle. The specified vehicle is one of the other vehicles 80. As will be described later, when the navigation image designated by the designation information is the confirmation image G3, the specified-vehicle information is appended to the designation information. The specified-vehicle information indicates the other vehicle 80 that is designated as the specified vehicle. The CPU 21 uses the other vehicle 80 corresponding to the specified-vehicle information as the specified vehicle.

When generating the confirmation image G3, the CPU 21 first determines the subject range. Specifically, the CPU 21 identifies the present position of the specified vehicle on the map data M based on the travel information of the specified vehicle. Then, the CPU 21 sets a hypothetical rectangular frame centered on the present position of the specified vehicle on the map data M on the assumption that the map data M is used at a predetermined scale. The predetermined scale is as described in the section of the generation of the normal image G1. Similarly, the hypothetical rectangular frame is as described in the section of the generation of the normal image G1. When the hypothetical rectangular frame is set on the map data M, the CPU 21 determines the entire area within the hypothetical rectangular frame as the subject range. When the subject range is determined, the CPU 21 generates a map image of the subject range.

Thereafter, the CPU 21 superimposes various types of display items reflecting the travel information of the specified vehicles on the generated map image. The types of the display item are the same as those described in the section of the normal image G1. Specifically, the display items include an icon Q1 indicating the present position of the specified vehicle, a character string NAME indicating the registered name of the specified vehicle, a line Q2 indicating the scheduled travel route of the specified vehicle, and a character string TR indicating the required time to the destination. The shape and color of icon Q1 indicating the present position of the specified vehicle are the same as those applied to the specified vehicle when the overall image G2 was generated. The same applies to the color of line Q2 indicating the scheduled travel route. In the same manner as the normal image G1, when the destination of the specified vehicle exists within the range of the generated map image, the CPU 21 superimposes an icon indicating the destination on the map image. At the same time, the CPU 21 superimposes a character string indicating the estimated arrival time around the icon indicating the destination. When vehicles other than the specified vehicle are present within the range of the generated map image, the CPU 21 superimposes icons indicating the present positions of the other vehicles.

Thereafter, the CPU 21 superimposes various types of operating buttons on the map image. The operating buttons include the NORMAL button BX, the ALL button BY, the zoom-in button BK1, the zoom-out button BK2, and the end button BE. The function of each operating button is as described above. The NORMAL button BX corresponds to the first button in the confirmation image G3. The ALL button BY corresponds to the second button in the confirmation image G3. The operating buttons are arranged, for example, at the left and right corners of the map image. When the navigation image is the confirmation image G3, the operating buttons include an ascending-order button BL1 and a descending-order button BL2. The ascending-order button BL1 and the descending-order button BL2 are buttons for inputting an instruction signal for changing the designation of the specified vehicle to the information processor 20. The specified vehicle that is currently designated will be referred to as the reference vehicle. The ascending-order button BL1 designates, as the specified vehicle, the other vehicle 80 that is the second farthest from the subject vehicle 10 next to the reference vehicle. When the reference vehicle is the other vehicle 80 that is farthest from the subject vehicle 10, the ascending-order button BL1 designates the other vehicle 80 closest to the subject vehicle 10 as the specified vehicle. The descending-order button BL2 is used to designate, as the specified vehicle, the other vehicle 80 that is the second closest to the subject vehicle 10 next to the reference vehicle. When the reference vehicle is the other vehicle 80 closest to the subject vehicle 10, the descending-order button BL2 designates the other vehicle 80 farthest from the subject vehicle 10 as the specified vehicle. The ascending-order button BL1 and the descending-order button BL2 are arranged, for example, near the upper edge of the map image.

### Update of Designation Information

The process of step S60 will be described in detail. There are the following two patterns in which the content shown on the display 30 is requested to be switched by operation of the operating buttons. A first pattern corresponds to a request to change the type of the navigation image shown on the display 30. A second pattern corresponds to a request to change the specified vehicle when the navigation image is the confirmation image G3. In step S60, the CPU 21 performs processing in accordance with the request that corresponds to each of these patterns. Specifically, in step S60, the CPU 21 updates the designation information in accordance with the operation of the operating button or updates the specified-vehicle information appended to the designation information. A process for updating the designation information and the like in each pattern will be described below.

The first pattern will now be described. If the NORMAL button BX is operated when the overall image G2 or the confirmation image G3 is displayed, the CPU 21 deletes the designation information currently stored in the memory 22. Then, the CPU 21 generates new designation information for designating the normal image G1. If the ALL button BY is operated when the normal image G1 or the confirmation image G3 is displayed, the CPU 21 deletes the designation information currently stored in the memory 22. Then, the CPU 21 generates new designation information for designating the overall image G2. If the CONFIRM button BZ is operated when the normal image G1 or the overall image G2 is displayed, the CPU 21 deletes the designation information currently stored in the memory 22. Then, the CPU 21 generates new designation information for designating the confirmation image G3. In addition, when the CONFIRM button BZ is operated, the CPU 21 generates the specified-vehicle information for designating the other vehicle 80 closest to the subject vehicle 10 as the specified vehicle. Then, the CPU 21 appends the specified-vehicle information to the designation information. In this manner, the specified-vehicle information is set in response to the operation of the CONFIRM button BZ. Thus, the specified vehicle is the other vehicle 80 designated by the driver through the input operation on the display 30.

The second pattern will now be described. If the ascending-order button BL1 or the descending-order button BL2 is operated when the confirmation image G3 is displayed, the CPU 21 deletes the specified-vehicle information currently stored in the memory 22. Then, the CPU 21 generates new specified-vehicle information. In this case, the CPU 21 sets the specified vehicle designated by the specified-vehicle information to the other vehicle 80 designated through the operation of the ascending-order button BL or the descending-order button BL2. Then, the CPU 21 appends the new specified-vehicle information obtained by changing the specified vehicle to the designation information. The CPU 21 stores the specified-vehicle information in the memory 22 together with the designation information. In the case of the second pattern, the navigation image designated by the designation information remains as the confirmation image G3.

### Operation of Embodiment

An example assumes that the normal image G1 is designated by the designation information. In this case, as shown in FIG. 3, the CPU 21 generates the normal image G1 in accordance with the designation information (step S30). Then, the CPU 21 shows the generated normal image G1 on the entire area of the display screen 32 of the display 30 (step S40). Subsequently, for example, the ALL button BY in the normal image G1 is operated (step S50: YES). In this case, the CPU 21 changes the navigation image designated by the designation information to the overall image G2 (step S60). Then, as shown in FIG. 4, the CPU 21 generates the overall image G2 in accordance with the designation information (step S30). The CPU 21 shows the generated overall image G2 on the entire area of the display screen 32 (step S40). Subsequently, for example, the CONFIRM button BZ in the overall image G2 is operated (step S50: YES). In this case, the CPU 21 changes the navigation image designated by the designation information to the confirmation image G3 (step S60). Then, as shown in FIG. 5, the CPU 21 generates the confirmation image G3 in accordance with the designation information (step S30). The CPU 21 shows the generated confirmation image G3 on the entire area of the display screen 32 (step S40). As described above, the CPU 21 always shows only one of the three types of navigation images on the display 30. As a feature of the present embodiment, the CPU 21 performs the following in response to operation by an occupant on the display 30. Specifically, the CPU 21 switches the manner in which the three types of navigation images are shown on the display 30 as follows. The CPU 21 switches the content shown on the display 30 from the navigation image that is displayed to the navigation image that is not displayed. The CPU 21 may switch the shown content of the same type of navigation image in response to the operation on the operating button by the driver. That is, if the ascending-order button BL1 or the descending-order button BL2 is operated when the confirmation image G3 is shown on the display 30, the CPU 21 changes the specified-vehicle information. Accordingly, the CPU 21 switch the confirmation image G3 shown on the display 30 to a confirmation image G3 centered on the specified vehicle that is different from the previous specified vehicle.

### Advantages of Embodiment

(1) In a vehicle including a navigation device described in

BACKGROUND section, a driver may need to make a travel plan taking into consideration the movement of other vehicles. In this case, the navigation device may be configured to obtain position information of the other vehicles and show the present positions of the other vehicles on the map image on the display device. However, when the present position of the subject vehicle and the present positions of the other vehicles are far away from one another, the other vehicles may not be shown on the map image depending on the scale of the map image shown by the navigation device. In this case, the driver of the subject vehicle needs to adjust the scale and the display range of the map image in order to include the other vehicles on the map image. It is troublesome for the driver of the subject vehicle to display the other vehicles on the map image.

In the navigation device 50 of the present embodiment, the CPU 21 is configured to generate three types of navigation images. This allows the driver of the subject vehicle 10 to use the three types of navigation images to make a travel plan while the subject vehicle 10 is traveling. The availability of the three types of navigation images has the following advantages for the driver. That is, the driver can check the present position of the subject vehicle 10 by using the normal image G1. In addition, the driver can check the present positional relationship between the other vehicles 80 and the subject vehicle 10 by using the overall image G2. Further, the driver can check the details of the present positions of the other vehicles 80 by using the confirmation image G3. In this manner, the driver can check the movement of the other vehicles 80 in addition to that of the subject vehicle 10. This allows the driver to easily make a driving plan taking into consideration the movement of the other vehicles 80. In addition, in the present embodiment, the driver can switch the manner in which the content is shown on the display 30 so that the driver can easily obtain desired information from various types of information on the navigation image. Therefore, the driver can readily obtain necessary information without having to change the scale of the navigation image or the display range of the navigation image, for example. The navigation device 50 improves convenience for the user when the user makes a driving plan taking into consideration the movement of the other vehicles 80.

(2) The CPU 21 shows only one navigation image on the display screen 32 of the display 30. This allows the CPU 21 to show one navigation image in a large size on the display screen 32. Thus, the driver of the subject vehicle 10 can easily check the content of the navigation image shown on the display screen 32. The CPU 21 includes two switching buttons, namely, the first button and the second button, in each navigation image. These switching buttons have the following advantages for the driver. Specifically, the driver can switch the navigation image shown on the display screen 32 by simply operating these switching buttons.

(3) The CPU 21 includes the scheduled travel routes of the vehicles in the navigation images. Since the information of the scheduled travel routes is included in the navigation images, the driver of the subject vehicle 10 can adjust the driving route, for example, by changing the driving route of the subject vehicle 10 in accordance with the scheduled travel routes of the other vehicles 80. In particular, the overall image G2 shows the scheduled travel route from the present position to the destination for all the vehicles. This allows the driver to determine the driving route taking into consideration the overall image of forthcoming situation of each vehicle.

(4) The CPU 21 includes, in each navigation image, information on the time related to the arrival at the destination, such as the required time to the destination and the estimated time of arrival at the destination. As a result, the driver of the subject vehicle 10 can adjust the driving time by taking a rest, changing the driving route so as to arrive at the destination early, or the like.

### Modified Examples

The above embodiment may be modified as follows. The above embodiment and the following modifications can be combined as long as the combined modifications remain technically consistent with each other.

The character string of the time-related information may be omitted from the navigation image.

The icon of the destination and the line of the scheduled travel route may be omitted from the navigation image.

The subject range of the overall image G2 does not have to include the destinations of all the vehicles.

The zoom-in button BK1 and the zoom-out button BK may be arranged in the overall image G2.

The various types of operating buttons may be omitted from the navigation image. In addition, the display 30 may be of a non-touch panel type. In this case, as the input device, for example, another device arranged in the passenger compartment, such as a switch provided on the steering wheel, may be used.

The modes of switching the manner in which the three types of navigation images are displayed are not limited to the examples of the above embodiment. For example, all of the three types of navigation images may be shown on the display screen 32 of the display 30. In this case, one of the three types is displayed in a larger size than the other two. Then, the navigation image shown in a larger size is changed in accordance with operation of the input device.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A navigation device configured to be mounted on a vehicle, the navigation device comprising:
an information processor that stores map data in advance;
a display configured to show an image that corresponds to information output by the information processor; and
an input device configured to input information to the information processor from outside the information processor,
wherein the information processor is configured to:
obtain information on present positions of vehicles registered in advance, the vehicles including a subject vehicle on which the navigation device is mounted;
show on the display a navigation image in which an icon indicating the present position of a corresponding one of the vehicles is superimposed on a map image of a subject range;
generate, as the navigation image, a normal image in which the subject range is set to a range including the present position of the subject vehicle, an overall image in which the subject range is set to a range including the present positions of all of the vehicles, and a confirmation image in which the subject range is set to a range including the present position of a specified vehicle designated by an input from the input device, the specified vehicle being one of the vehicles; and
switch a manner in which three types of the navigation images are displayed in accordance with an input from the input device.

2. The navigation device according to claim 1, wherein
the display is of a touch panel type that also has a functionality of the input device, and
the information processor is further configured to:
show on the display a first button, a second button, and only one of the three types of the navigation images;
switch, when the first button is operated, the navigation image shown on the display to one of two navigation images not shown on the display; and
switch, when the second button is operated, the navigation image shown on the display to an other one of the two navigation images not shown on the display.

3. The navigation device according to claim 1, wherein the information processor is further configured to:
obtain, from each of the vehicles, information on a destination and a scheduled travel route from the present position to the destination;
generate, as the navigation image, an image in which the scheduled travel route is superimposed on the map image within the subject range of the map image; and
set, when generating the overall image, the subject range of the overall image to a range including the destinations of all of the vehicles in addition to the present positions of all of the vehicles.

4. The navigation device according to claim 3, wherein the information processor is further configured to:
obtain, from each of the vehicles, time-related information including at least one of an estimated arrival time at the destination and a required time to the destination; and
generate, as the navigation image, an image in which the time-related information of any of the vehicles located within the subject range of the map image is superimposed on the map image.

5. A non-transitory computer readable storage medium storing a navigation program that includes instructions executed by a computer, the instructions of the navigation program cause the computer to:
obtain information on present positions of vehicles registered in advance, the vehicles including a subject vehicle on which the navigation device is mounted;
output, to outside the storage medium, a navigation image in which an icon indicating the present position of a corresponding one of the vehicles is superimposed on a map image of a subject range;
generate, as the navigation image, a normal image in which the subject range is set to a range including the present position of the subject vehicle, an overall image in which the subject range is set to a range including the present positions of all of the vehicles, and a confirmation image in which the subject range is set to a range including the present position of a specified vehicle designated by an input from outside the storage medium, the specified vehicle being one of the vehicles; and
switch a manner in which three types of the navigation images are displayed in accordance with an input from outside the storage medium.
